(19) United States
(12) Patent Application Publication
(10) Pub. No.: US 2005/0197820 A1
(43) Pub. Date: Sep. 8, 2005

(54) Management of sets of resources used in different simulations

(76) Inventors: Aaron L. Ehrensberger, State College, PA (US); Grace A. Reuss, State College, PA (US); James B. Hopkins, State College, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/792,295

(22) Filed: Mar. 2, 2004

(51) Int. Cl. G06F 9/45

(52) U.S. Cl. 703/22

(57) ABSTRACT

A plurality of resources are managed that are used in simulations. Resources are associated with two or more different resource sets. The resource sets are then associated with one or more different simulations. The resources may include electronic document images, application program components that execute from within other applications, animations, and web pages.

### COMPACT DISC APPENDIX

This patent application includes an Appendix on one compact disc having a file named appendix.txt, created on Mar. 2, 2004, and having a size of 49,743 bytes. The compact disc is incorporated by reference into the present patent application.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Computer-assisted educational tools are exploding in popularity, especially in government and corporate continuing education settings. One type of educational tool is a simulation. The general public is most familiar with simulation programs through popular computer video games such as SimCity™ (available from Electronic Arts Inc.) and RollerCoaster Tycoon (available from Atari®, formerly Infogrames Entertainment S.A.). However, simulation programs are now being used in business environments for training and education. For example, a simulation may be used to teach how to read a financial statement and how specific business decisions may impact the balance sheet of a specific company. SimShop™, available from Strategic Management Group, Inc. (SMG), Philadelphia, Pa., is a platform for development, maintenance and deployment of simulations. By enhancing the capabilities of the simulation platform, the simulation experiences can be improved and made more flexible. The present invention provides for such enhancements.

Many large applications, such as SimShop simulations, are experienced by users via the World Wide Web (i.e., the Web). The Web allows information to be accessed over the Internet. The Web is an information-sharing model that is built on top of the Internet. The Web uses the HTTP protocol to transmit data. The Web also uses browsers, such as Internet Explorer or Netscape, to access Web documents called Web pages that are linked to each other via hyperlinks. Web documents may contain graphics, sounds, text and video.

Simulations use a plurality of electronic “resources” to provide a media-rich experience to the user. A resource can be any sort of data that would be useful in a simulation experience. Examples of resources include a video clip (e.g., an interaction between people which illustrates a learning concept), a spreadsheet (e.g., a financial statement of a company), a data file (current state of pending orders or employee output), textual material (e.g., background articles or references about a specific topic), a software tool (e.g., financial calculator).

When a simulation needs to present or access a resource during a simulation, the simulation software is programmed with a hardcoded link to refer directly to the resource. Oftentimes, a plurality of related resources need to be presented or accessed at a particular point in a simulation. For example, a tutorial on how to read a balance sheet may use five specific resources. In this case, the simulation software is programmed with five hardcoded links to the resources. Another simulation prepared for a different customer or prepared on a similar subject may also call for the same balance sheet tutorial. This requires programming the other simulation with the same five links. As resources change and need to be updated, each simulation would need to be modified and then tested for each resource change or addition. If one client wanted to add their own unique resources to the simulation, a copy of the simulation would need to be created and modified to add their resources and then tested. As a result, two nearly identical simulations would need to be maintained instead of one.

It would be desirable to more efficiently manage resources to simplify the process of creating simulations that share similar groups of resources. The present invention fulfills this need.

### BRIEF SUMMARY OF THE INVENTION

A Resource Library is provided which allows for the dynamic association of resources with a simulation. In this manner, a single resource can be used in any number of simulations across multiple initiatives. A customer may add, freshen, and maintain their own resources, and have them integrated dynamically with a simulation. The Resource Library offers a card catalog of references to resources, allowing users to link directly to online content.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

In the drawings:

FIG. 1 shows selected resources in a Resources Library.

FIG. 2 is a diagram that shows how resources are organized into sets in accordance with one preferred embodiment of the present invention.

FIG. 3 is a diagram that shows how actual resources are organized into sets.

FIG. 4 is a sample display screen showing a simulation scene and resources that can be accessed related to the simulation scene.

### DETAILED DESCRIPTION OF THE INVENTION

Certain terminology is used herein for convenience only and is not to be taken as a limitation on the present invention.

The present invention is described in the context of the SimShop™ platform described above. However, the scope of the present invention is not limited to any particular simulation platform.

I. Overview of Present Invention

A method is provided to manage a plurality of resources that are used in simulations. To implement the method, at least some of the resources are associated with two or more different resource sets. One or more resource sets may then be associated with one or more different simulations. The resources may be public or private. The private resources may be restricted to selected users.

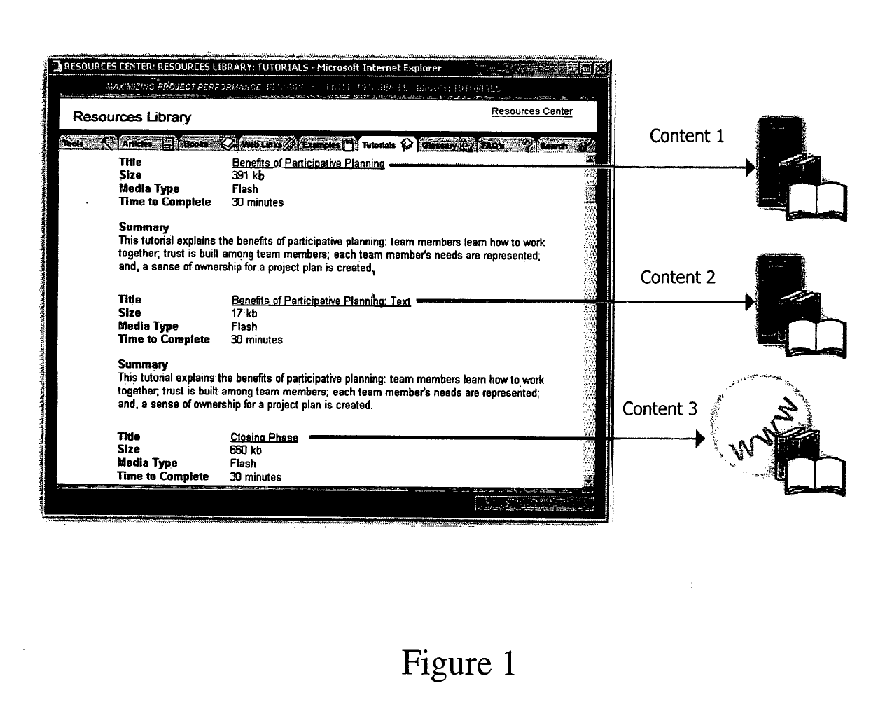

FIG. 1 shows selected resources in a Resources Library. These resources are Macromedia Flash® animation files. A resource may be located anywhere in the world. The Resource Library is similar to a card catalog in a library. Each resource is identified by bibliographic information. The location of the resource is embedded in the hyperlink of the title.

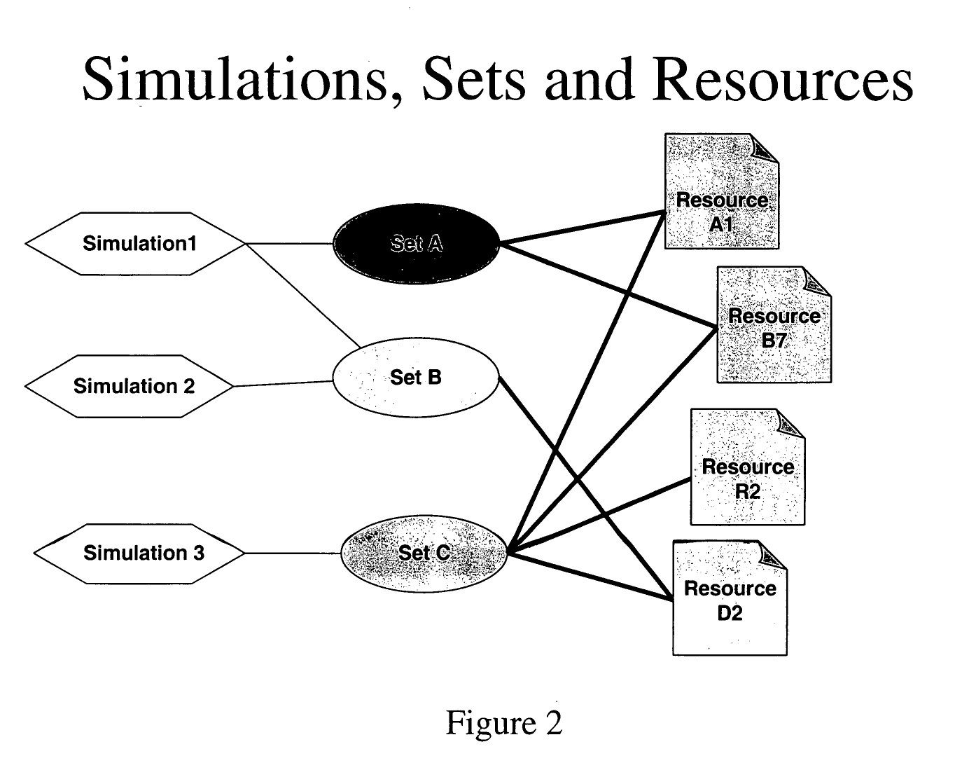

FIG. 2 shows pictorially how resources are organized into sets.

II. Detailed Disclosure

The following design details are used to implement the present invention:
1. Resources are put into sets.
2. Sets are associated with a simulation.
3. Company resources are marked as private so only users of a specific company can see them.
4. When a simulation displays a list of resources, it uses the set, so resources can be updated without changing the simulation.
5. Different simulations can reference the same sets.

Part 1 of the Appendix provides sample source code for implementing the following features in accordance with one embodiment of the present invention:
1. Structure of the data tables
2. Code that adds a resource to a set.
3. Code that assigns sets to simulations.
4. Code that gets the sets for a simulation.
5. Code that queries resources for a user in a simulation.

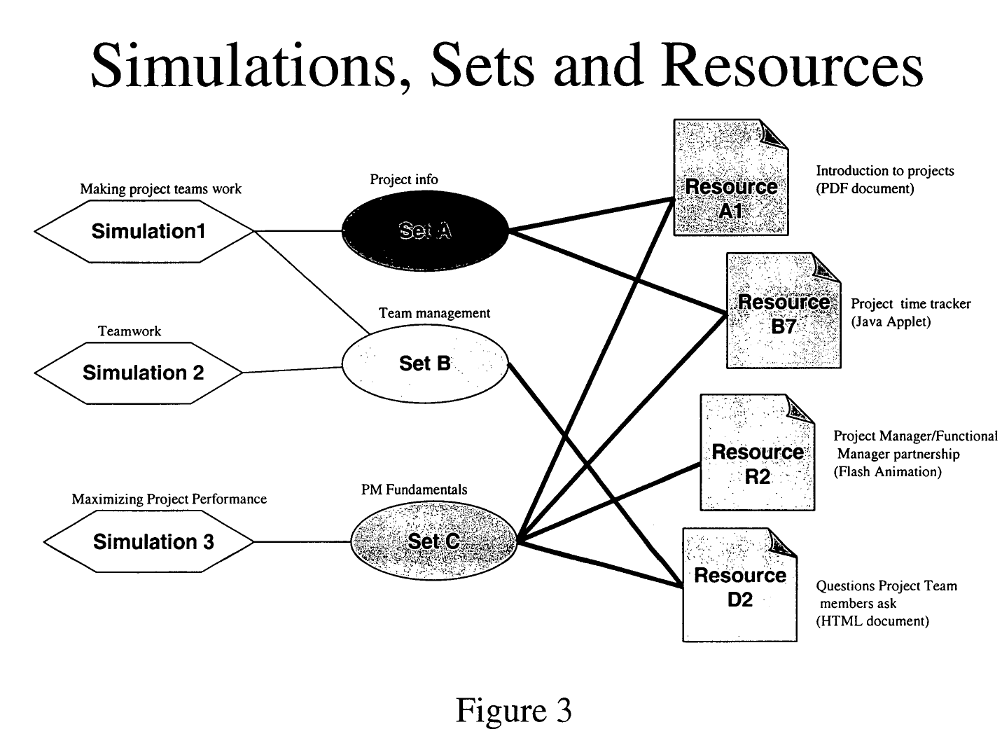

FIG. 3 shows an exemplary embodiment of actual resources organized into sets. A document called “Introduction to projects” and a project time tracker applet are resources in a set called Project info. That set is associated with the “Making project teams work” simulation. The “Maximizing Project Performance” simulation uses all four resources because it is associated with the “PM Fundamentals” set which has all four resources in it. Additional resources can be added to a set, and therefore to the simulation, without making any changes to the simulation itself. Queries can be made to relate a subset of resources from a set to a specific part of the simulation. Resources may include electronic documents (e.g., Word documents), electronic document images (e.g., PDF documents), application program components that execute from within other applications (e.g., Java Applets), animations (e.g., Flash animation), and web pages (e.g., HTML documents).

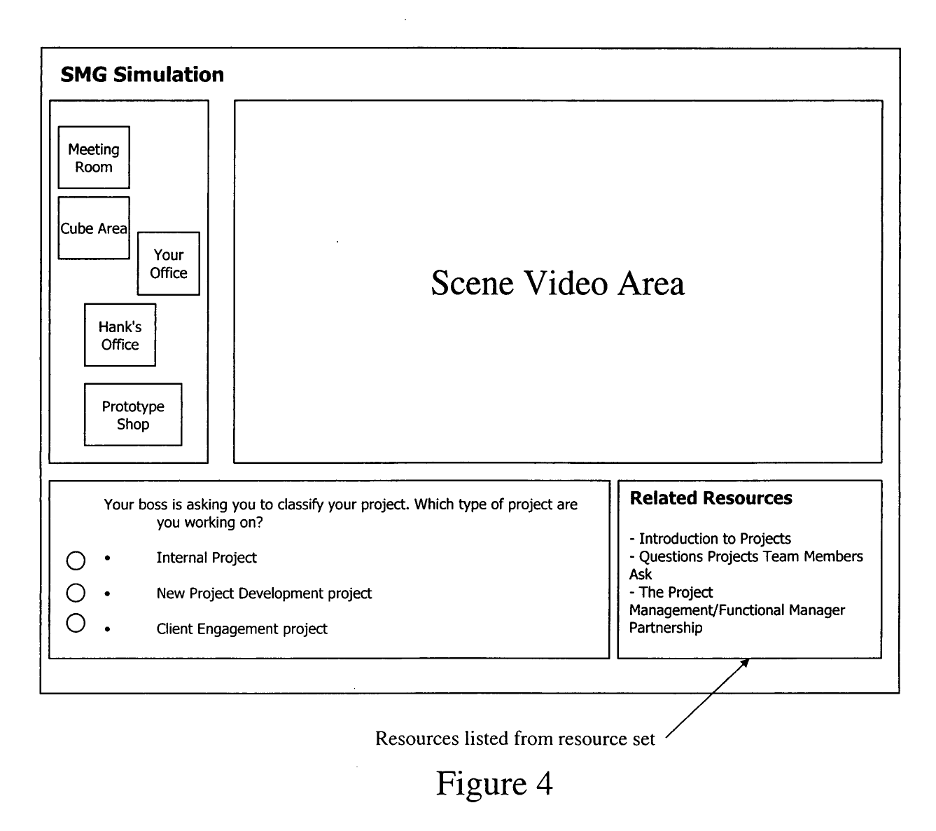

FIG. 4 shows a screen shot of a decision scene from the Maximizing Project Performance simulation in which a keyword search is done within the “PM Fundamentals” set to pull out the three resources related to that scene. Resources can be added or removed from the scene by adding or removing them from the set and optionally specifying a keyword when searching is used. Prior to the present invention, adding a related resource to a scene involved editing the specific scene page to add the hardcoded link, and then retesting the simulation.

Parts 2A and 2B of the Appendix provide sample source code for the resource set example of FIG. 4.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A method of managing a plurality of resources that are used in simulations, the method comprising:
(a) associating at least some of the resources with two or more different resource sets; and
(b) associating one or more resource sets with one or more different simulations.

2. The method of claim 1 wherein step (b) further comprises associating one or more resource sets with two or more different simulations.

3. The method of claim 1 wherein the one or more different simulations are executed by a plurality of users, the resources including public and private resources, the method further comprising:
(c) restricting private resources to selected users.

4. The method of claim 1 wherein one or more of the resources are electronic document images.

5. The method of claim 1 wherein one or more of the resources are application program components that execute from within other applications

6. The method of claim 1 wherein one or more of the resources are animations.

7. The method of claim 1 wherein one or more of the resources are web pages.

8. An apparatus for managing a plurality of resources that are used in simulations, the method comprising:
(a) means for associating at least some of the resources with two or more different resource sets; and
(b) means for associating one or more resource sets with one or more different simulations.

9. The apparatus of claim 8 wherein the means for associating associates one or more resource sets with two or more different simulations.

10. The apparatus of claim 8 wherein the one or more different simulations are executed by a plurality of users, the resources including public and private resources, the apparatus further comprising:
(c) means for restricting private resources to selected users.

11. The apparatus of claim 8 wherein one or more of the resources are electronic document images.

12. The apparatus of claim 8 wherein one or more of the resources are application program components that execute from within other applications

13. The apparatus of claim 8 wherein one or more of the resources are animations.

14. The apparatus of claim 8 wherein one or more of the resources are web pages.

15. An article of manufacture for managing a plurality of resources that are used in simulations, the article of manufacture comprising a computer-readable medium holding computer-executable instructions for performing a method comprising:
(a) associating at least some of the resources with two or more different resource sets; and
(b) associating one or more resource sets with one or more different simulations.

16. The article of manufacture of claim 15 wherein step (b) further comprises associating one or more resource sets with two or more different simulations.

17. The article of manufacture of claim 15 wherein the one or more different simulations are executed by a plurality of users, the resources including public and private resources, the computer-executable instructions performing a method further comprising:
(c) restricting private resources to selected users.

18. The article of manufacture of claim 15 wherein one or more of the resources are electronic document images.

19. The article of manufacture of claim 15 wherein one or more of the resources are application program components that execute from within other applications

20. The article of manufacture of claim 15 wherein one or more of the resources are animations.

21. The article of manufacture of claim 15 wherein one or more of the resources are web pages.
